(19) United States
(12) Patent Application Publication
(10) Pub. No.: US 2009/0199962 A1
(43) Pub. Date: Aug. 13, 2009

(54) Delamination tool with enhanced force response

(76) Inventor: Ivan Legostaev, JR., Antelope, CA (US)

Correspondence Address: Ivan Legostaev, 4213 Eagle Ridge Way, Antelope, CA, 95843, US

(21) Appl. No.: 12/069,661

(22) Filed: Feb. 11, 2008

(51) Int. Cl. B32B 37/00

(52) U.S. Cl. 156/247; 156/584

(57) ABSTRACT

The present invention is directed to a tool for de-laminating two or more bonded material layers wherein two simultaneous force vectors are applied to the tool so as to control the resulting effect of the tool. In particular, the tool is comprised of a handle, a shaft having a proximal and a distal end, a working face, and a strike plate. The handle is connected to the proximal end of the shaft wherein the shaft has a finite length. At the distal end of the shaft is a working face which may be either integral to the shaft or is a separate element which is durably attached to the shaft. At a point on the shaft between the proximal or handle end, and the distal or working face end, a strike plate is durably attached to the shaft. The strike plate is configured to receiving repeated impact by a drive source.

### BACKGROUND

Impact tools are of particular importance in affecting a surface that requires treatment or modification. Chisels, scrapers, blades, and gouges are common examples of impact tools which are used to remove layers of material, de-scale surface, de-laminate bonded layers and the like. In general application these kinds and types of impact tools are used at an obtuse angle to the surface to be treated, wherein a working face is in direct contact with the surface, and a drive force is applied to the distal end of the impact tool through repeated blows by a weighted mass. Due to the obtuse angle employed in directing the impact tool against the surface, particularly when a shallow depth between bonded pieces to be separated is desired, it can become problematic for the operator to maintain precise and continuous control over the depth which the impact tool is driven. Further, as the obtuse angle increases in order to achieve a shallow treatment depth, the distance between the distal end of the tool and the surface decreases accordingly. This decrease in height of the distal end of the impact tool becomes problematic in the operator being able to apply sufficient impact force, especially imparting that impact force without risk of deleterious impact of the drive force on the surface itself versus the impact tool.

Numerous means and methods have been described for facilitating use of impact tools at high obtuse angles. U.S. Pat. No. 7,251,895 to Kurtz is directed to a thin bladed chisel which has a very thin cross-section profile and is allowed to bend during use so that a less obtuse angle can be achieved. U.S. Pat. No. 5,301,429 to Bundy is directed to an impact tool having a compound bend in the shaft of the tool so that additional distal height can be attained relative to the surface to be treated. U.S. Pat. No. 5,219,378 to Arnold utilizes a plastic and radiused blade as a means for decreasing the obtuse angle and allow for de-lamination of bonded structures.

A specific industry wherein very thin bonded materials require de-lamination is the field of automotive repair and restoration. Previously, automotive panels have been fabricated from plural thin layers of metal which have been welded together in small regions or “spots”. New developments in adhesive chemistry have allowed the fabrication of automotive panels to evolve from welding technologies to chemical bonding technologies. Regardless of the bonding means, automotive panels may require de-lamination in order to affect replacement or restoration of one or more of the components layers due to collision, impact, warping or material deterioration. Prior art attempts to address means for affecting de-lamination of layers in bonded automotive panels predominantly focus on bar type devices having a beveled edge and wherein the bar is struck at an indeterminate position on the bar, as exemplified in U.S. Pat. No. 7,258,896 to Kurtz. The indeterminate strike position is particularly deleterious, if not otherwise dangerous, as the bar material deforms under repeated impact, creating rolled-over or “mushroomed” elements of the bar at the strike points which can in turn break away from the bar and cause secondary projectile injury to the operator.

Each of the aforementioned tools offers a means for improving the controllability of an impact driven device to affect de-lamination of plural bonded material layers. However, there remains an unmet need to obviate the obtuse impact angle issue all together while at the same time improving controllability and safety of the tool by the operator for precise applications and for extended periods-of time.

### SUMMARY OF THE INVENTION

The present invention is directed to a tool for de-laminating two or more bonded material layers wherein two simultaneous force vectors are applied to the tool so as to control the resulting effect of the tool. In particular, the tool is comprised of a handle, a shaft having a proximal and a distal end, a working face, and a strike plate. The handle is connected to the proximal end of the shaft wherein the shaft has a finite length. At the distal end of the shaft is a working face which may be either integral to the shaft or is a separate element which is durably attached to the shaft. At a point on the shaft between the proximal or handle end, and the distal or working face end, a strike plate is durably attached to the shaft. The strike plate is configured to receiving repeated impact by a drive source. Suitable drive sources include, but are not limited to, manually operated discontinuous devices such as weighted head or dead-blow type hammers as well as continuous service devices such as pneumatic and electrically powered impact hammers.

In practical application, an operator applies at least one force vector (FV1) by grasping the handle of the present invention and directing the coinciding work face against a surface by applying force in a direction approximately perpendicular to the surface. Simultaneous to the application by the operator of a force vectored perpendicular to the surface to be treated, the operator applies a drive source to the shaft mounted strike plate. The drive source provides a force vector (FV2) on the tool and the attached working face vectored in a direction approximately parallel to the surface to be treated and at a nominal 90° angle (plus or minus 45° deflection) to the first force vector applied by the operator. By simultaneous application of a perpendicular force vector (FV1) and a parallel force vector (FV2), it is possible for the operator to affect the de-lamination of bonded material layers with the working face of the tool with a high degree of depth control and precision for protracted periods of time.

It is further within the purview of the present invention that the operator may apply yet a third force simultaneously upon the tool by applying a torque (FV3) to the handle of the tool. By applying torque the operator can not only control depth but also direction of continuous travel of the tool as the parallel force vector (FV2) induces linear translation between the layers to be de-laminated.

The working face of the tool may include one or more functional attributes dependent upon the bonded material layers to be de-laminated (i.e. whether spot welded or chemical adhesive bonded) and the desired effect obtained. Representative functional attributes include, but are not limited to, flat and/or radiused flat profiles, beveled, curved or blunt edges, variable thicknesses and the combinations thereof. Further, the composition of the working face may be the same as or different than the composition of the tool shaft and may be adapted to work with specific substrates such as plastic and metal.

Other features and advantages of the present invention will become readily apparent from the following detailed description, the accompanying drawings, and the appended claims.

### BRIEF SUMMARY OF THE FIGURES

The invention will be more easily understood by a detailed explanation of the invention including drawings. Accordingly, drawings which are particularly suited for explaining the inventions are attached herewith; however, it should be understood that such drawings are for descriptive purposes only and as thus are not necessarily to scale beyond the measurements provided. The drawings are briefly described as follows:

FIG. 1 is a left side view of a representative de-lamination tool in accordance with the present invention

FIG. 2 is a front view of a representative de-lamination tool.

FIG. 3 is a back view of a representative de-lamination tool.

FIG. 4 is a right side view of a representative de-lamination tool.

FIG. 5 is a proximal end, top-down view of a representative de-lamination tool.

FIG. 6 is a distal end, bottom-up view of a representative de-lamination tool.

FIG. 7 is a side view of a representative de-lamination tool being used by an operator to separate two bonded material layers wherein the drive source is a manual hammer.

FIG. 8 is a side view of a representative de-lamination tool in accordance with the present invention wherein the strike plate has a receiving groove for a pneumatic or electric hammer.

FIG. 9 is a back view of a representative de-lamination tool wherein the strike plate has a receiving groove for a pneumatic or electric hammer.

FIG. 10 is a side view of a representative de-lamination tool being used by an operator to treat a surface wherein the drive source is a pneumatic or electric hammer.

FIG. 11 is a left side view of exemplary alternate blade profiles as may be employed in the working face of the de-lamination tool.

FIG. 12 is a right side view of the working face wherein the blade is adjustably affixed to the working face.

FIG. 13 is a left side view of a representative impact tool having a first and a second strike plate located at the same point between the proximal and the distal end of the tool shaft.

FIG. 14 is a left side view of a representative impact tool having a first and a second strike plate located at different points between the proximal and the distal end of the tool shaft.

### DETAILED DESCRIPTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

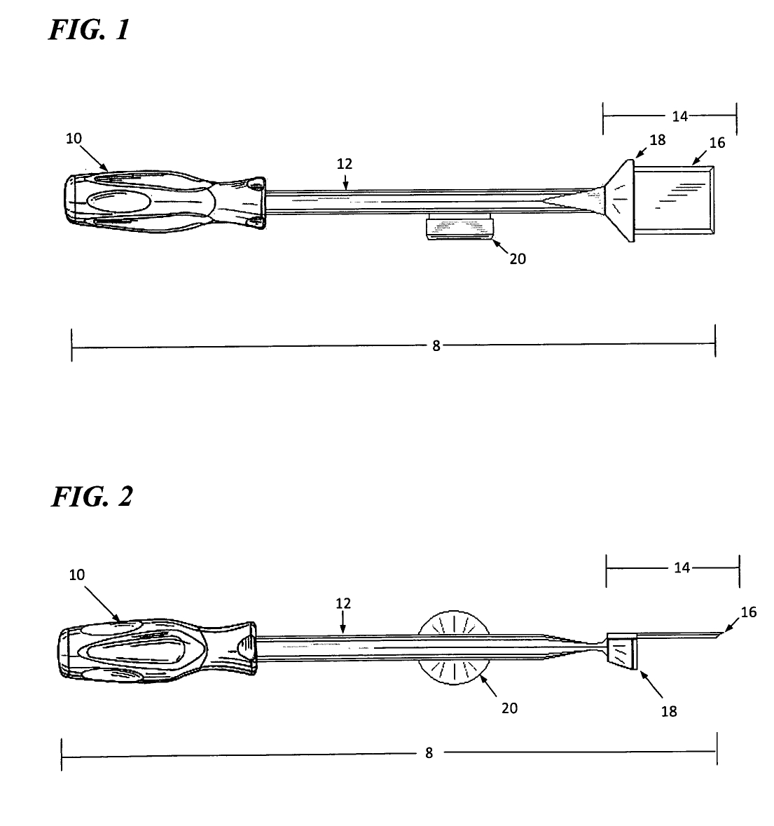

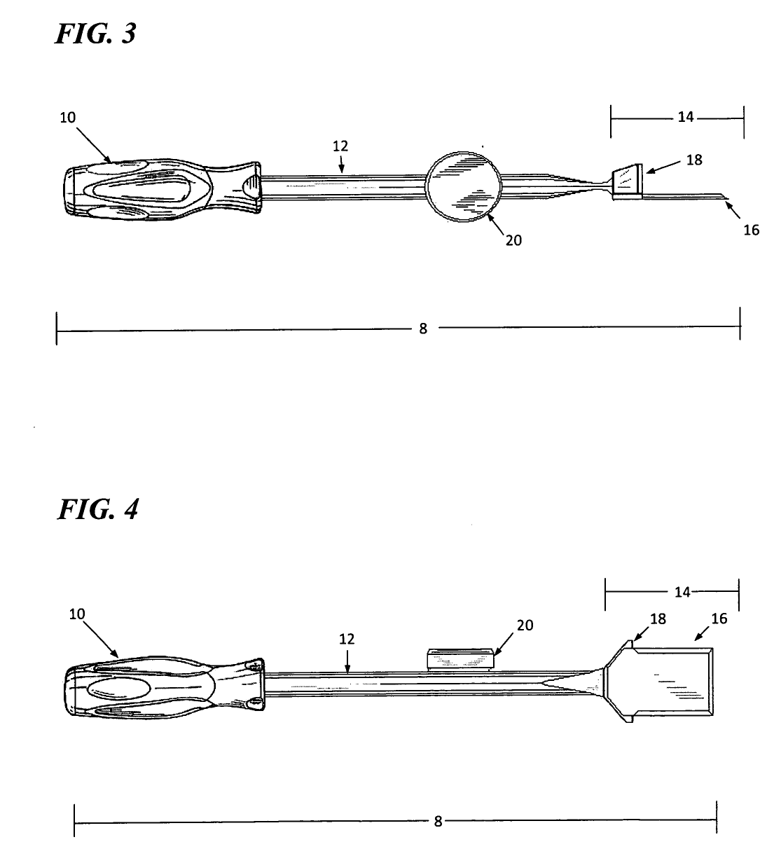

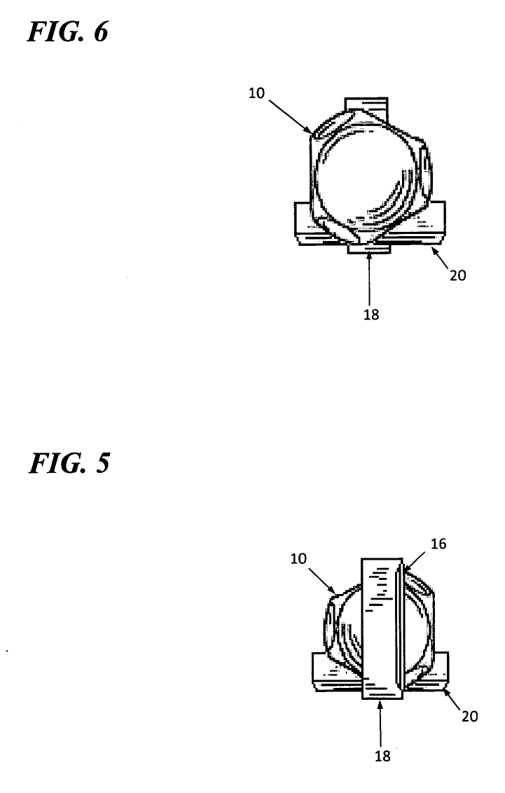

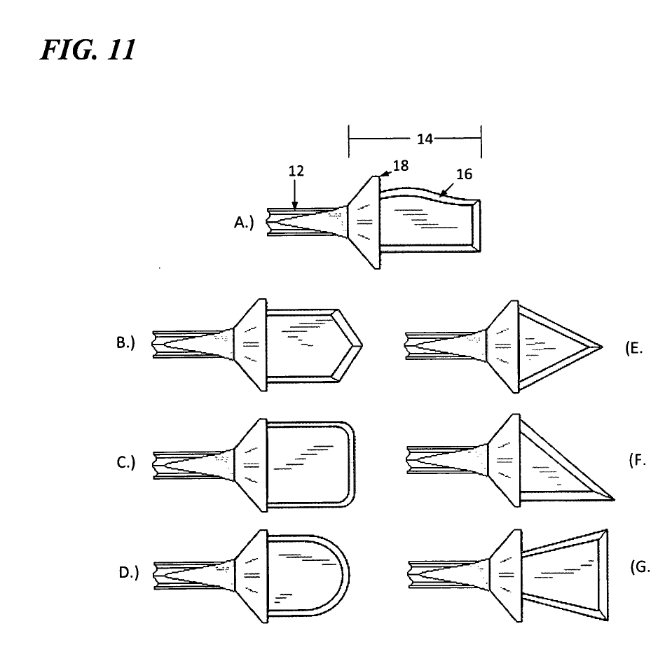

The present invention is directed to a tool for modifying or interacting with a surface wherein two simultaneous force vectors are applied to the tool so as to control the resulting effect of the tool. As depicted in FIGS. 1 through 14, and specifically in FIG. 1, impact tool 8 is generally comprised of a handle 10, a shaft having a proximal and a distal end 12, a working face 14, a blade element 16 and a strike plate 20.

Handle 10 is connected to the proximal end of shaft 12 wherein the shaft has a finite length. Preferably, shaft 12 is between 6 and 18 inches in length, though specialized applications wherein a longer or shorter shaft is desirable in order to access a contact point are possible. Handle 10 is designed to be held by the operator and any suitable design or geometric cross section can be employed so long as the profile is sufficient to fit a human hand. The composition of handle 10 may include wood, polymer, fiberglass or metal and can be produced by injection moulding, sintering, or carving from the desired materials. The handle may include shock absorbing elements and/or fillers such as elastomeric polymer or rubber bushings so that repeated impact of strike plate 20 by a drive source does not cause undue fatigue with the operator. Handle 10 may also include multiple or compound profiles such as depending on the degree of perpendicular force or torque required to perform a desired de-lamination treatment, the operator may enjoy an optimized ergonomic state.

Shaft 12 is comprised of a composition having superior ductile strength so as to remain durable to protracted periods of repeated impact on strike plate 20. Tool steels such as chrome vanadium are desirable for their combined machineability and high ductile strength. There is no constraint on the cross-sectional geometry of shaft 12 and may include profiles including angled, curved, and combinations thereof. Further, shaft 12 need not have a common diameter throughout the finite length of the shaft nor must the shaft have the same cross-sectional profile at any two points along shaft length.

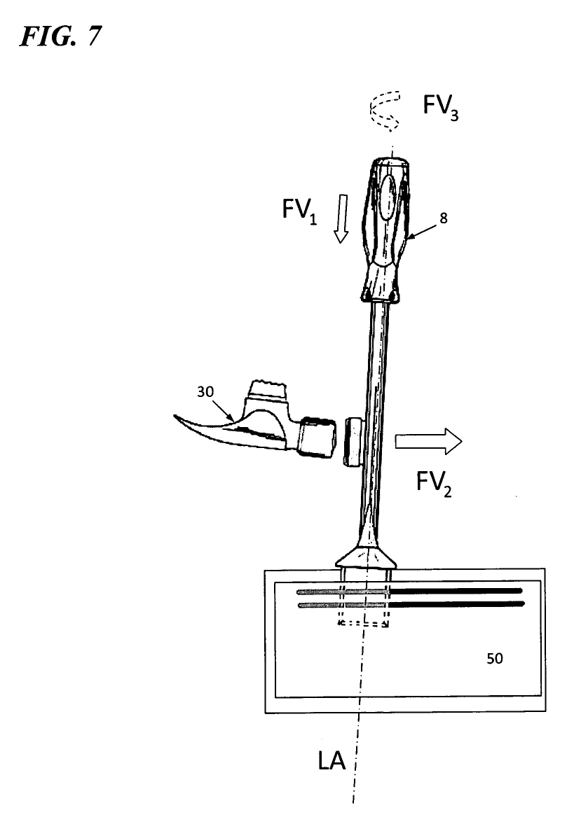

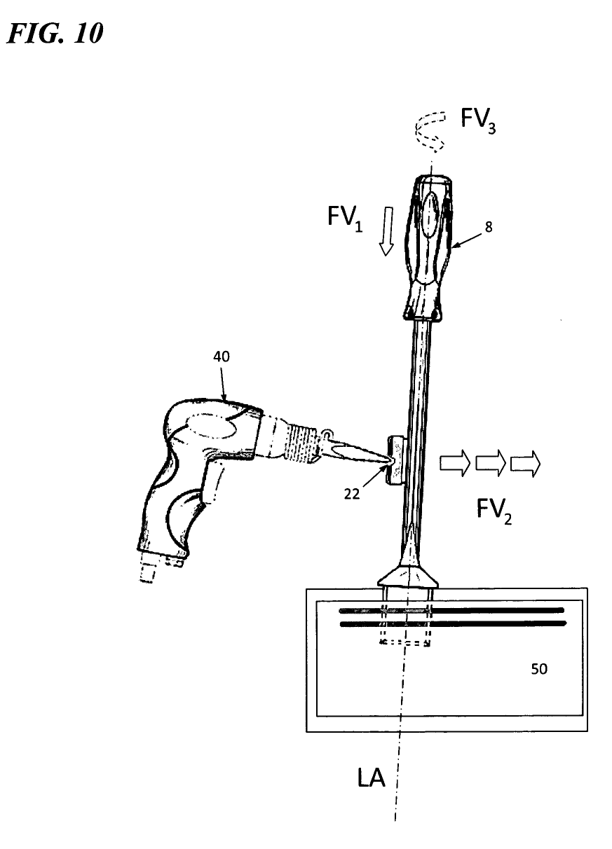

At the distal end of shaft 12 is working face 14. Working face 14 may be either integral to shaft 12 or it may be a separate element which is durably attached to the shaft within the range of 0 to 110 degrees departure from the long axis (LA) of tool 8, and may be optionally replicable or reparable. Within working face 14 is blade element 16. Blade element 16 may include one or more functional attributes dependent upon the bonded material layers to be de-laminated 50 (depicted in FIGS. 7 and 10) and the desired effect obtained. Representative functional attributes of blade element 16 include, but are not limited to, blades having flat and/or radiused profiles, beveled, curved or blunt edges, variable thicknesses (generally from about 0.005 inch to 0.125 inch) and the combinations thereof. Blade element 16 may be configured to have the same or different functional attributes about an outer edge circumference of the blade element, wherein the different functional attributes can be utilized by directing a drive source in a direction such that the desired functional attribute engages bonded material layers 50. Further, the composition of working face 14 and blade element 16 may be the same as or different than the composition of the tool shaft and may be adapted to work with specific substrates such as plastics and metals.

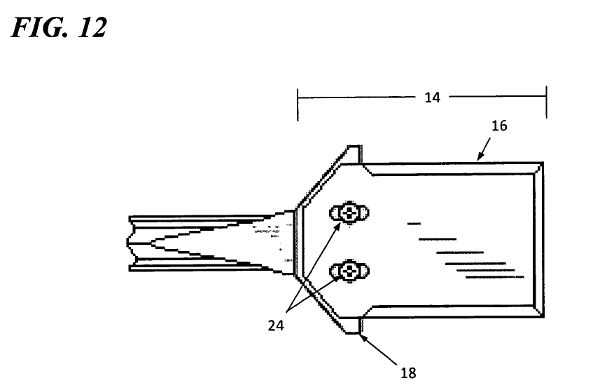

Working face 14 may optionally include guide block 18. Guide block 18 is positioned such that the degree of penetration between bonded material layers of blade element 16 is desirably limited to a finite level. Blade element 16 may be integral to guide block 18 and thus exhibit a constant limitation of blade element 16 penetration between bonded material layers, or as shown in FIG. 12, blade element may be adjustably engaged to guide block 18 to allow an operator to change the degree of desired penetration between bonded material layers by blade element 16 through adjustment of recessed tension screws 24.

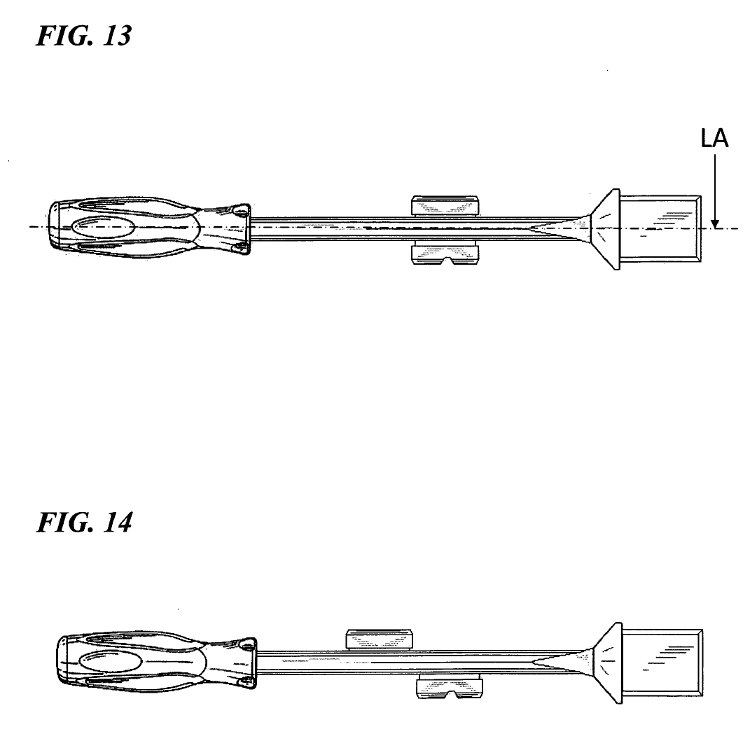

At a point on shaft 12 between the proximal or handle end, and the distal or working face end, at least one strike plate 20 is durably attached to shaft 20. Strike plate 20 is configured for receiving repeated impact by a drive source creating a force vectored approximately parallel to the direction of the bonded material layers to be de-laminated (FV2) and is oriented on shaft 12 such that working face 14 is oriented in the direction of FV2. Strike plate 20 is preferably fabricated from material or materials having a high degree of impact resistance without being brittle, and is effective at transmitting force without undue deformation or force absorption. Suitable materials for strike plate 20 include high durometer polymers of 70 or higher as determined by ASTM D2240-00, malleable metals such as lead, copper or mild steel, and combinations of such materials in laminate or composite constructions. In the event that working face 14 has multiple functional attributes, additional strike plates may be affixed to shaft 12, at either equivalent (FIG. 13) or differing (FIG. 14) points along the length of shaft 12, such that by rotation of the de-lamination tool about a long axis allows for a different functional attribute to be employed and a separate strike plate be utilized to impart a alternate force vector favorable to the functional attribute.

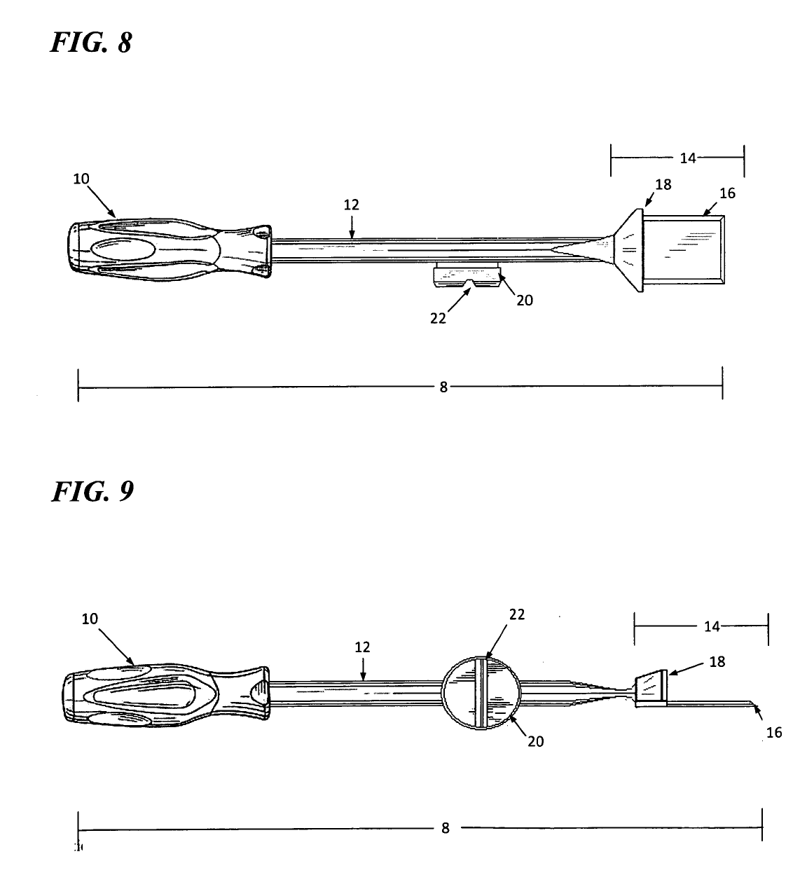

Suitable drive sources include, but are not limited to, manually operated discontinuous devices 30 such as weighted head or dead-blow type hammers as well as continuous service devices 40 such as pneumatic and electrically powered impact hammers. When a strike plate 20 is expected to be struck with a drive source, either of a manual operated discontinuous or a continuous service device, the strike plate should have an available contact surface area of at least 130% of the surface area of the drive source contact area (i.e. the surface area of the impact face of the hammer head or of the fitment itself). The contact surface area defined by strike plate is not constrained to a specific surface area profile, and may include elliptical (as shown in FIGS. 1 through 14), rectangular, trapezoidal, polyhedral, or combinations of differing surface area profiles. In addition to a strike plate 20 having a contact surface area, or in lieu of a contact surface area, the strike plate may have a receiving area 22 (shown in FIGS. 8 through 10). Receiving area 22 is design to have a notch, trough, circular recess, or other profile suitable to retain a blade or other fitment in a continuous service device. Such receiving area 22 is specifically designed to allow the blade or other fitment a means to remain in contact with strike plate 20 without undue slippage.

In practical application, FIGS. 7 and 10 show application at least one force vector (FV1) by grasping the handle of the present invention and directing the coinciding work face 14 against a bonded material layer surface 50 by applying force in a direction perpendicular to that surface. Simultaneous to the application by the operator of a force vectored perpendicular to the surface to be treated (FV1); the operator applies a drive source (manual drive source in FIG. 7 and continuous service drive source in FIG. 10) to a shaft mounted strike plate 20. The drive source provides a force on tool 8 and the attached working face vectored in a direction essentially parallel to the surface to be treated (FV2) and at a nominal 90° angle (plus or minus 45° deflection) to the first force vector (FV1) applied by the operator. By simultaneous application of a perpendicular force vector (FV1) and a parallel force vector (FV2), is it possible for the operator to affect the surface to be treated 50 with working face 14 of tool 8 with a high degree of depth control and precision for protracted periods of time.

As depicted in FIGS. 7 and 10, it is further within the purview of the present invention that the operator may apply yet a third force vector simultaneously upon the tool by applying a torque (FV3) to handle 10 of tool 8. By applying torque the operator can not only control depth but also direction of continuous travel of tool 8 as the parallel force vector induces linear translation across the surface to be de-laminated.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

1. A de-lamination tool comprising;
a. A shaft having a proximal and distal end;
b. A handle affixed to said proximal end of said shaft;
c. A working face affixed to distal end of said shift;
d. A blade element affixed to said working face;
e. A strike plate affixed to said shaft at a point between said proximal and said distal end of said shaft; and
wherein said strike plate is oriented on said shaft that upon impact with a suitable drive source, said blade element moves in a direction parallel to the direction of impact.

2. A de-lamination tool as in claim 1, wherein said shaft is between 6 and 18 inches in length.

3. A de-lamination tool as in claim 1, wherein said working face is integral to the shaft.

4. A de-lamination tool as in claim 1, wherein said blade element is replicable.

5. A de-lamination tool as in claim 1, wherein said strike plate is impacted upon by a drive source.

6. A de-lamination tool as in claim 5, wherein said strike plate has a surface contact area of at least 130% of the drive source contact area.

7. A de-lamination tool as in claim 1, wherein said blade element is adjustably affixed to said working face.

8. A de-lamination tool as in claim 1, wherein said blade element has more than one functional attribute.

9. A de-lamination tool as in claim 1, wherein said working face further includes a guide block.

10. A de-lamination tool as in claim 1, wherein said strike plate is comprised of a polymer having a durometer greater than 70 as measured by ASTM D2240-00.

11. A de-lamination tool as in claim 1, wherein said strike plate is comprised of a malleable metal.

12. A de-lamination tool as in claim 1, wherein said strike plate further includes a receiving area for a continuous service drive source.

13. A de-lamination tool as in claim 1, wherein said de-lamination tool has more than one strike plate affixed to said shaft.

14. A de-lamination tool as in claim 13, wherein said plural strike plates are comprised of differing materials.

15. A de-lamination tool as in claim 13, wherein said plural strike plates are located at different points between said proximal and said distal end of said shaft.

16. A method for using a de-lamination tool comprising;
a. An de-lamination tool comprising;
i. A shaft having a proximal and distal end;
ii. A handle affixed to said proximal end of said shaft;
iii. A working face affixed to distal end of said shift;
iv. A blade element affixed to said working face;
v. A strike plate affixed to said shaft at a point between said proximal and said distal end of said shaft;
wherein said strike plate is oriented on said shaft that upon impact with a suitable drive source, said blade element moves in a direction parallel to the direction of impact;
b. A surface having two or more bonded material layers;
c. A drive source;
wherein said de-lamination tool is held by said handle such that said working face is in contact with said surface and imparting a force perpendicular to said surface;
wherein said drive source is placed in contact with said strike plate of said de-lamination tool, imparting a force parallel to said surface; and
wherein said blade element of said working face is driven between and causes separation of the bonded material layers.

17. A method for using a de-lamination tool as in claim 16, wherein said strike plate has a surface contact area of at least 130% of the drive source contact area.

18. A method for using a de-lamination tool as in claim 16, wherein said drive source is a manually operated weighted-head hammer.

19. A method for using a de-lamination tool as in claim 16, wherein said drive source is a continuous service device.

20. A method for using a de-lamination tool as in claim 16, wherein said surface having two or more bonded material layers is an automotive panel.
